(19) United States
(12) Patent Application Publication
(10) Pub. No.: US 2004/0065080 A1
(43) Pub. Date: Apr. 8, 2004

(54) Energy storage system and method

(76) Inventor: Ted S. Fasca, Leesburg, VA (US)

Correspondence Address: Richard C. Litman, LITMAN LAW OFFICES, LTD., P.O. BOX 15035, Arlington, VA, 22215, US

(21) Appl. No.: 10/664,019

(22) Filed: Sep. 17, 2003

Related U.S. Application Data
(60) Provisional application No. 60/415,750, filed on Oct. 4, 2002.

(51) Int. Cl. F16D 31/00

(52) U.S. Cl. 60/325

(57) ABSTRACT

A system and method for storing energy during an off-peak period and distributing energy during a peak period in a wholesale energy market. The system has a first energy directing device for directing energy produced in the wholesale energy market during the off-peak period into an energy storage device, and a second energy directing device for directing the energy from said energy storage device into the wholesale energy market during the peak period. Also, a method for creating profit in a wholesale energy market.

### CROSS-REFERENCE TO RELATED APPLICATION

This application claims the benefit of U.S. Provisional Patent Application Serial No. 60/415,750, filed Oct. 4, 2002, which is herein incorporated by reference.

### FIELD OF THE INVENTION

The present invention relates to a device and method for storing energy during an off-peak period and distributing and/or selling energy during a peak period in a wholesale energy market.

### DESCRIPTION OF RELATED ART

Deregulation of the energy market has led to the development of wholesale energy markets in which energy producers pool together their supplies of energy, form a market, determine a price for energy, and sell the energy to energy consumers. In a typical wholesale energy market, such as the PJM Interchange (formerly known as the Pennsylvania-New Jersey Maryland Interchange), there are three main types of power generation: fossil fuel, nuclear and renewable. Fossil fuel power generation includes coal, gas and oil powered plants. Renewable power generation includes hydro, solar and wind powered plants. 79% of the U.S. wholesale energy market is supplied by fossil fuel sources, 20% by nuclear and 1% by renewable sources. Power is produced and supplied to the wholesale energy market as needed. Power production is increased during peak hours and decreased during off-peak hours.

Base load units, such as coal fired plants, must run continuously because the cost of shutting down and starting up the units are prohibitively high. Because demand for power is low during the off-peak period, not all of the power produced by the base load units is consumed. Further, in the wholesale energy market, the power that is purchased during the off-peak period must be sold at a market price. The market price is typically lower than the cost to produce the power. Therefore, power producers in the wholesale energy market must operate their base load units at a loss during the off-peak period.

While a variety of devices have been proposed for storing energy, none have been provided for use in the wholesale energy market. There is a need for an energy storage system and/or method for storing energy during an off-peak period and distributing energy during a peak period in a wholesale market.

The related art is represented by the following references of interest.

U.S. Patent Application Publication No. 2001/0010222 A1, printed on Aug. 2, 2001 for Melvin L. Prueitt, describes a solar power generation and energy storage system. The Prueitt application does not suggest an energy storage system and/or method according to the claimed invention.

U.S. Patent Application Publication No. 2002/0000306 A1, published on Jan. 3, 2002 for James E. Bradley, describes methods and devices for storing energy utilizing phase change material. The Bradley application does not suggest an energy storage system and/or method according to the claimed invention.

U.S. Patent Application Publication No. 2002/0041126 A1, published on Apr. 11, 2002 for John H. Provanzana et al., describes a power load-leveling system and packet electrical storage utilizing capacitors. The Provanzana et al. application does not suggest an energy storage system and/or method according to the claimed invention.

U.S. Pat. No. 4,532,769, issued on Aug. 6, 1985 to Lyle A. Vestermark, describes an energy storing flywheel assembly in which first and second reels are operatively connected by a flexible band, with the first and second reels capable of being rotated by first and second electric motors, and the second reel that can rotate either clockwise or counter clockwise through a clutch mechanism driving a flywheel. The Vestervark patent does not suggest an energy storage system and/or method according to the claimed invention.

U.S. Pat. No. 5,093,770, issued on Mar. 3, 1992 to John L. Davenport, describes an electrical energy storage system for altering the state of a magnetic actuator in order to effect the opening or closing of an associated circuit breaker. The Davenport patent does not suggest an energy storage system and/or method according to the claimed invention.

U.S. Pat. No. 5,200,687, issued on Apr. 6, 1993 to Jonas Lindblom et al., describes an energy storage system for use in a receptacle having terminals connected to conductors for establishing an electric circuit. The Lindblom et al. patent does not suggest an energy storage system and/or method according to the claimed invention.

U.S. Pat. No. 5,368,957, issued on Nov. 29, 1994 to Ivan D. Kozmik et al., describes an energy storage device with novel cathode materials. The Kozmik et al. patent does not suggest an energy storage system and/or method according to the claimed invention.

U.S. Pat. No. 5,373,195, issued on Dec. 18, 1994 to Rik W. A. A. De Doncker et al., describes a technique for decoupling the energy storage system voltage from the DC link voltage in AC electric drive systems. The De Doncker et al. patent does not suggest an energy storage system and/or method according to the claimed invention.

U.S. Pat. No. 5,589,727, issued on Dec. 31, 1996 to D. Clint Seward, describes an energy storage device in which a vacuum tube and a magnetic field are used to store electrons circulating within the tube along spiral paths. The Seward patent does not suggest an energy storage system and/or method according to the claimed invention.

U.S. Pat. No. 5,093,770, issued on Mar. 3, 1992 to John L. Davenport, describes an electrical energy storage system for altering the state of a magnetic actuator in order to effect the opening or closing of an associated circuit breaker. The Davenport patent does not suggest an energy storage system and/or method according to the claimed invention.

U.S. Pat. No. 5,590,568, issued on Jan. 7, 1997 to Muneaki Takara, describes a device for rotating a layered body that includes multiple rotating plates arranged in equally spaced layers and coaxially aligned about an axis of rotation. The Takara patent does not suggest an energy storage system and/or method according to the claimed invention.

U.S. Pat. No. 5,610,802, issued on Mar. 11, 1997 to Phillip A. Eidler et al., describes an energy storage system including a housing adapted to rest on a supporting surface. The Eidler et al. patent does not suggest an energy storage system and/or method according to the claimed invention.

U.S. Pat. No. 5,614,777, issued on Mar. 25, 1997 to Jack G. Bitterly et al., describes a high speed rotating flywheel and an integral motor/generator unit. The Bitterly et al. patent does not suggest an energy storage system and/or method according to the claimed invention.

U.S. Pat. No. 5,655,617, issued on Aug. 12, 1997 to Herbert K. Marshall, describes an elastomeric energy storage system. The Marshall patent does not suggest an energy storage system and/or method according to the claimed invention.

U.S. Pat. No. 5,931,249, issued on Aug. 3, 1999 to Christopher W. H. Ellis et al., describes a kinetic energy storage system which utilizes a flywheel with a motor generator to store energy. The Ellis et al. patent does not suggest an energy storage system and/or method according to the claimed invention.

U.S. Pat. No. 5,936,375, issued on Aug. 10, 1999 to Masamitsu Enoki, describes a method for energy storage and recovery for load hoisting equipment driven by an inverter controlled first induction motor and having a second inverter controlling a second induction motor with drives a flywheel. The Enoki patent does not suggest an energy storage system and/or method according to the claimed invention.

U.S. Pat. No. 5,939,798, issued on Aug. 17, 1999 to Nicholas W. Miller, describes an energy storage system including a first power conversion device and a second power conversion device for providing energy to loads upon interruption of a main power source. The Miller patent does not suggest an energy storage system and/or method according to the claimed invention.

U.S. Pat. No. 5,948,562, issued on Sep. 7, 1999 to Michael Fulcher et al., describes electrochemical cells packaged in flexible foil laminate packages. The Fulcher et al. patent does not suggest an energy storage system and/or method according to the claimed invention.

European Patent Application Publication No. 0 511 829 A2, published, describes an energy storage system for receiving and storing electrical power and releasing the power to an electric circuit. The European '829 application does not suggest an energy storage system and/or method according to the claimed invention.

None of the above inventions and patents, taken either singly or in combination, is seen to describe the instant invention as claimed. Thus an energy storage system and method solving the aforementioned problems is desired.

### SUMMARY OF THE INVENTION

The present invention is an energy storage system and method for storing energy during an off-peak period and distributing energy during a peak period in a wholesale energy market. An energy storage system according to the invention includes a first energy directing device for directing energy produced in the wholesale energy market during the off-peak period into an energy storage device, and a second energy directing device for directing the energy from the energy storage device into the wholesale energy market during the peak period.

A method according to the invention produces energy in the wholesale energy market during the off-peak period, directs the produced energy into an energy storage device, stores the produced energy in the energy storage device, and directs the stored energy from the energy storage device into the wholesale energy market during the peak period.

A method for creating profit in a wholesale energy market according to the invention produces energy in the wholesale energy market during the off-peak period at an off-peak period price, directs the produced energy into an energy storage device, stores the produced energy in the energy storage device, directs the stored energy from the energy storage device into the wholesale energy market during the peak period, and sells the stored energy directed to the wholesale energy market at a peak period price.

Accordingly, it is a principal aspect of the invention to provide a system for storing energy during an off-peak period and distributing energy during a peak period in a wholesale energy market.

It is another aspect of the invention to provide a method of storing energy during an off-peak period and distributing energy during a peak period in a wholesale energy market.

It is a further aspect of the invention to provide a method for creating profit in a wholesale energy market.

It is an aspect of the invention to provide improved elements and arrangements thereof in an energy storage system and method for the purposes described which is inexpensive, dependable and fully effective in accomplishing their intended purposes.

These and other aspects of the present invention will become readily apparent upon further review of the following specification and drawings.

### BRIEF DESCRIPTION OF THE DRAWINGS

FIG. 1 is schematic view of a device for storing energy during an off-peak period and distributing energy during a peak period in a wholesale energy market according to the present invention.

FIG. 2 is a flow chart of a method of storing energy during an off-peak period and distributing energy during a peak period in a wholesale energy market.

FIG. 3 is a flow chart of a method for creating profit in a wholesale energy market.

FIG. 4 is a schematic view of various types of energy storage devices.

FIG. 5 is a schematic view of a mechanical potential energy storage system in a lowered position.

FIG. 6 is a schematic view of a mechanical potential energy storage system in a raised position.

FIG. 7 is a chart showing the average hourly Locational Market Price (LMP) for energy in the Potomac Electric Power Company (PEPCO) Zone of the PJM Interchange, which is one example of a wholesale energy market.

Similar reference characters denote corresponding features consistently throughout the attached drawings.

### DETAILED DESCRIPTION OF THE PREFERRED EMBODIMENTS

The present invention is an energy storage system and method for storing energy during an off-peak period and distributing energy during a peak period in a wholesale energy market. The invention disclosed herein is, of course, susceptible of embodiment in many different forms. Shown in the drawings and described herein below in detail are preferred embodiments of the invention. It is to be understood, however, that the present disclosure is an exemplification of the principles of the invention and does not limit the invention to the illustrated embodiments.

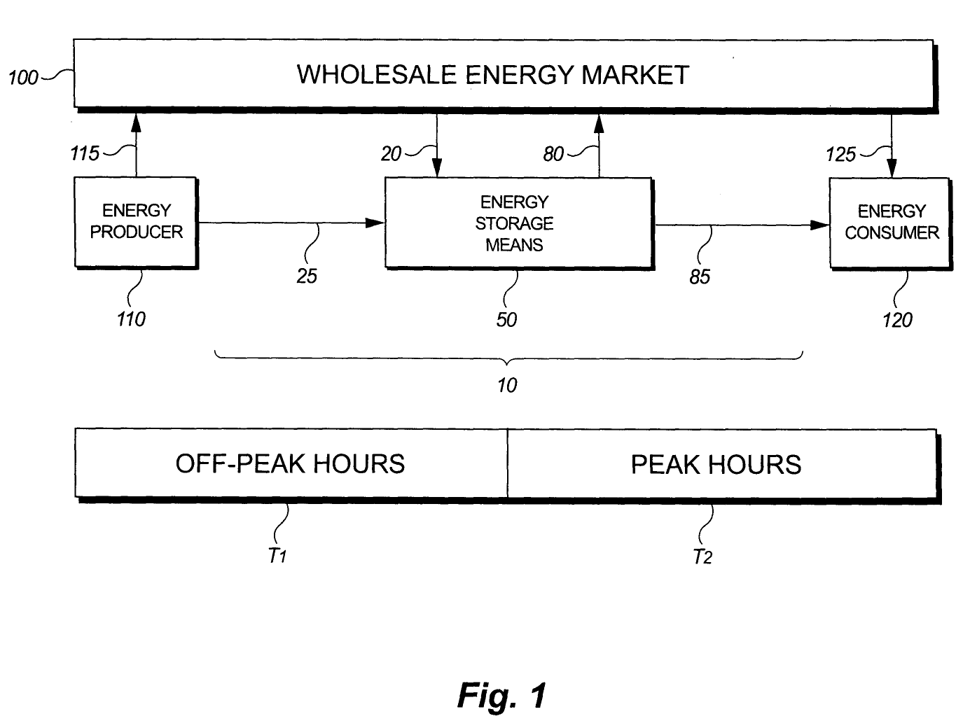

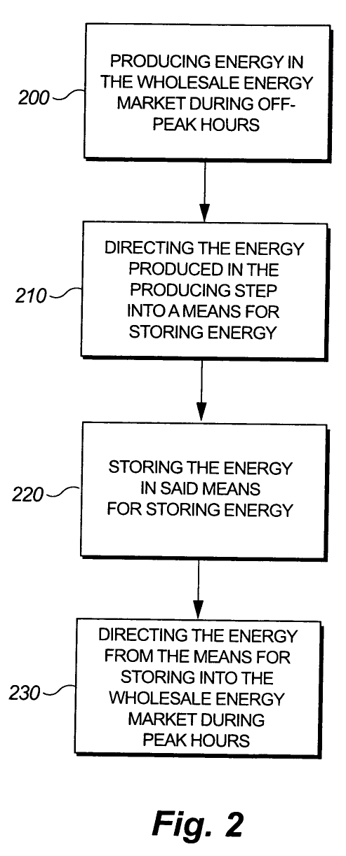

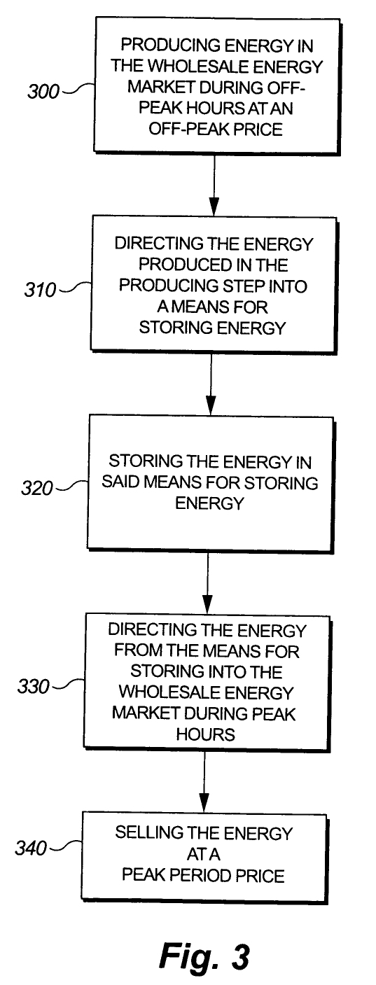

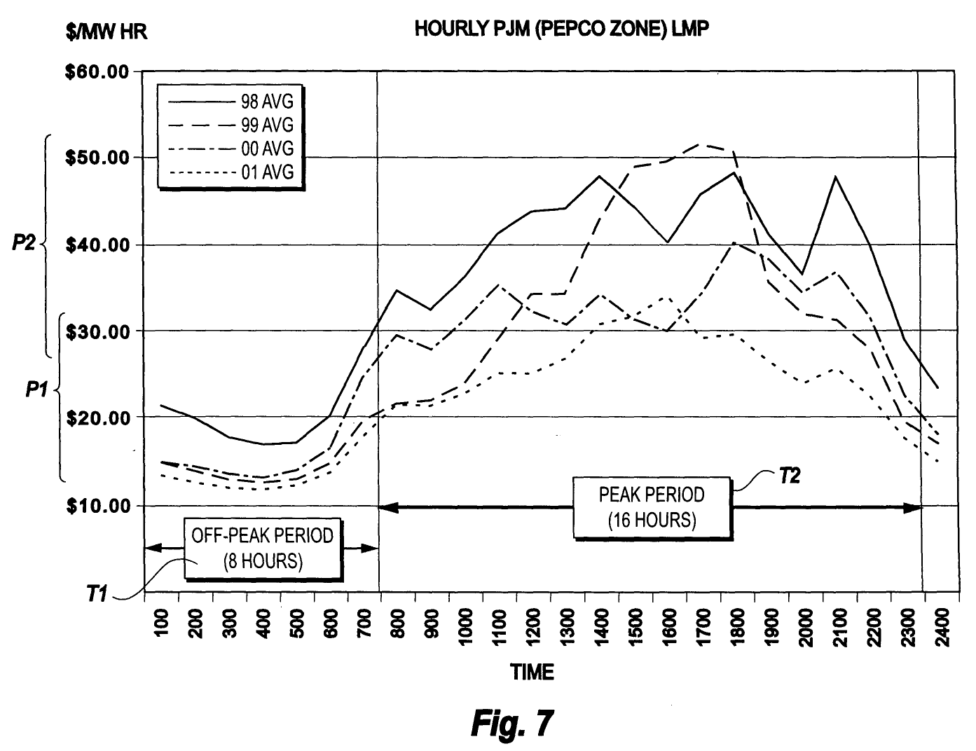

The present invention is directed to a system 10 for storing energy during an off-peak period and distributing energy during a peak period in a wholesale energy market (see FIGS. 1, 5 and 6). The present invention is also directed to a method of storing energy 200-230 during an off-peak period and distributing energy during a peak period in a wholesale energy market (see FIG. 2), and a method for creating profit 300-340 in a wholesale energy market (see FIGS. 3 and 7).

FIG. 7 shows the average hourly LMP for energy in the PEPCO Zone of the PJM Interchange, which is one example of a wholesale energy market. Price is expressed in terms of dollars per megawatt hour ($/MWHr) and includes average hourly prices for each year from 1998 to 2001. The off-peak period price P1 for energy during the off-peak period T1 in the wholesale energy market 100 is much lower than the peak period price P2 during the peak period T2. The present invention is directed toward a system and method for producing and storing energy during the off-peak period and distributing or selling the stored power during the peak period at a higher price.

As shown in FIG. 1, an energy producer 110 creates usable energy and directs it to the wholesale energy market 100 via a first means of transmission, such as first transmission lines 115. The energy producer 110 may be any type of electric power generator such as a nuclear, coal, gas, oil, hydro, wind or solar electric power generator. The wholesale energy market 100 directs the energy to an energy consumer 120 via a second means of transmission, such as second transmission lines 125. The energy consumer 120 may be any kind of electric power consumer, such as a residential, commercial or industrial consumer or another wholesale energy market. The first and second means of transmission could be any suitable device for transmitting energy from the energy producer 110 to the wholesale energy market 100 and from the wholesale energy market 100 to the energy consumer 120.

The system 10 of the present invention receives energy either from the wholesale energy market 100 or directly from the energy producer 110 via a first means of directing energy. The first means of directing energy may be any suitable device for transmitting energy, such as electric transmission lines 20, 25. If, for example, the energy is to be provided from the wholesale energy market 100, the energy may be transmitted to the system 10 via electric transmission lines 20. If the energy is to be provided directly from the energy producer 110, the energy may be transmitted to the system 10 via electric transmission lines 25.

The first means of directing energy is provided for directing energy produced in the wholesale energy market 100 or by the energy producer 110 during an off-peak period T1 into a means for storing energy 50. The off-peak period T1 is the period of time during which demand for energy and energy prices are comparatively low. For example, as shown in FIG. 7, the off-peak period T1 may be the eight hour time period from 12 midnight to 8 a.m. However, the off-peak period T1 may be a shorter or longer period of time depending on the particular supply and demand of the wholesale energy market 100. The means for storing energy 50 will be discussed in greater detail below.

The system 10 has a second means of directing energy for directing the energy from the means for storing energy 50 to the wholesale energy market 100 during a peak period T2. The second means of directing energy may be any suitable device for transmitting energy, such as electric transmission lines 80, 85. If, for example, the energy is to be directed to the wholesale energy market 100, the energy may be supplied from the system 10 via electric transmission lines 80. If the energy is to be directed directly to the energy consumer 120, the energy may be supplied from the system 10 via electric transmission lines 85. The peak period T2 is the period of time during which demand for energy and energy prices are comparatively high. For example, as shown in FIG. 7, the peak period T2 may be the sixteen hour time period from 8 a.m. to 12 midnight. However, the peak period T2 may be a shorter or longer period of time depending on the particular supply and demand of the wholesale energy market 100.

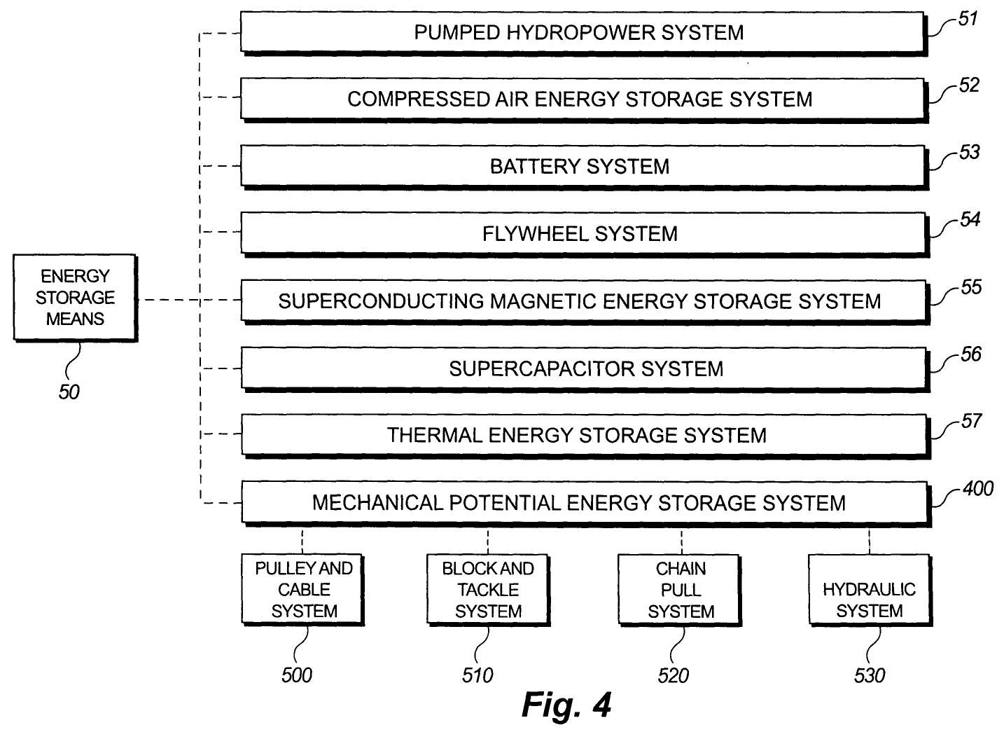

As shown in FIG. 4, the means for storing energy 50 may be a pumped hydropower system 51, a compressed air energy storage (CAES) system 52, a battery system 53, a flywheel system 54, a superconducting magnetic energy storage (SMES) system 55, a supercapacitor system 56, a thermal energy storage system 57, for example, using molten salt, or a mechanical potential energy storage system 400. All of these systems store energy by converting electric energy into another form of energy, and then converting the other form of energy back into electric energy.

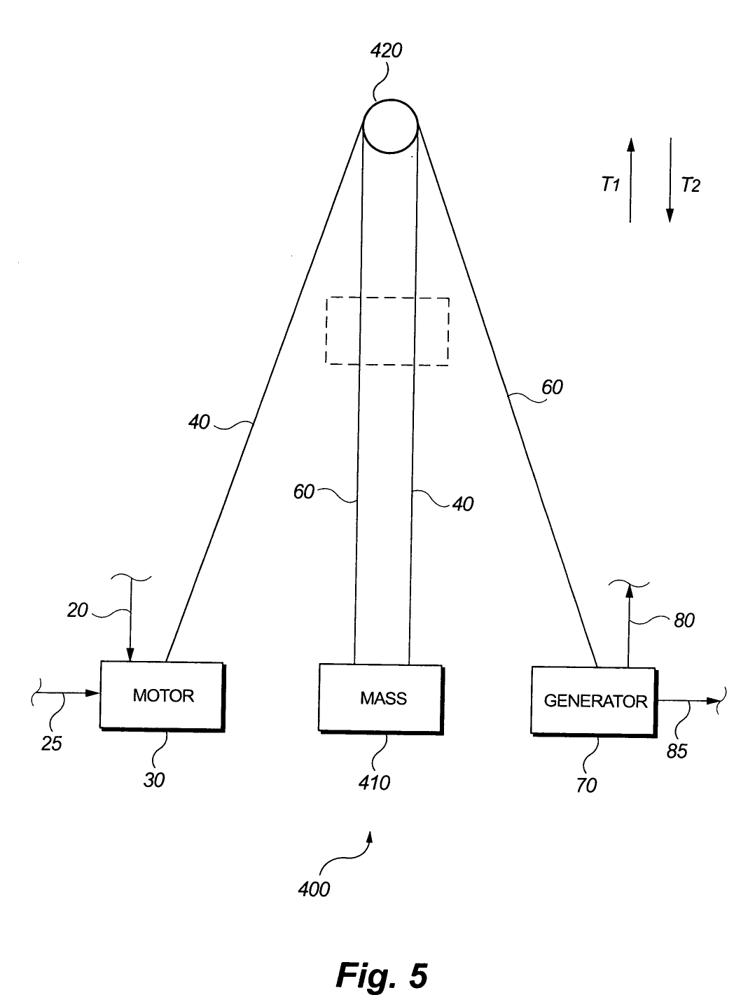

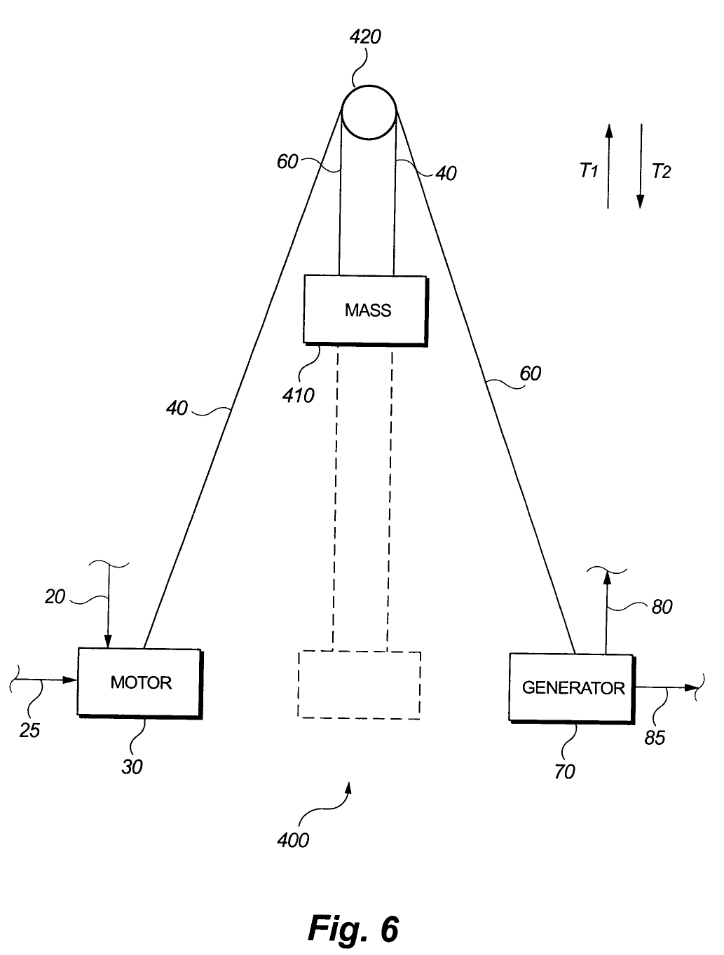

As shown in FIGS. 5 and 6, the means for storing energy 50 may be provided as a mechanical potential energy storage system 400. The mechanical potential energy storage system 400 may be provided, for example, with a mass 410, a means for lifting the mass 410, and a means for lowering the mass 410. The means for lifting the mass 410, and the means for lowering the mass 410 may be any suitable device for lifting the mass 410.

For example, the mass 410 may be lifted and lowered using a motor 30 connected to the mass 410 with a first cable 40. The first cable 40 may be attached to a pulley 420. The mass 410 is also connected to a generator 70 using a second cable 60, which may also be attached to the pulley 420. In operation, the mass 410 starts in a lowered position, as shown in FIG. 5. During the off-peak period T1, the motor 30 lifts the mass 410 with the means for lifting using the energy produced during the off-peak period T1 to create a potential energy. The mass 410 is then in a raised position, as shown in FIG. 6. During the peak period T2, the mass 410 is lowered with the means for lowering thereby supplying the second means for directing energy 80, 85 with energy. The mass 410 returns to the lowered position, as shown in FIG. 5.

The structure of the mechanical potential energy storage system 400 used to support the weight of the mass 410 may be, for example, a metal or concrete structure. There could be a single motor 30 and a single generator 70, or a plurality of motors and generators, as appropriate. The motor and generator could be separate devices or they may be provided in a single apparatus that is a combination motor/generator. In order to provide enough potential energy storage to be of use in the wholesale energy market 100, the mass 410 may be a single, large mass or a plurality of masses. The total mass for a device for use in the wholesale energy market is on the order of several thousand tons, and the mechanical potential energy storage system 400 is adapted to accommodate the forces which correspond with such a mass.

As shown in FIG. 4, the mechanical potential energy storage system 400 may be a pulley and cable system 500, a block and tackle system 510, a chain pull system 520, or a hydraulic system 530. All of these systems store energy in a manner similar to the manner described above and shown in FIGS. 5 and 6. The hydraulic system 530 does not require cables or pulleys to lift the mass, but includes the motor 30 and generator 70.

As shown in FIG. 2, the present invention is also directed to a method 200-230 of storing energy during an off-peak period T1 and distributing energy during a peak period T2 in the wholesale energy market 100. The method 200-230 has the steps of producing energy 200 in the wholesale energy market 100 during the off-peak period T1, a first directing step 210 of directing the energy produced in the producing step 200 into a means for storing energy 50, storing 220 the energy in the means for storing energy 50, and a second directing step 230 of directing the energy from the means for storing energy 50 into the wholesale energy market 100 during the peak period T2. The means for storing energy 50 of the method 200-230 may be provided in any of the embodiments described above.

As shown in FIGS. 3 and 7, the present invention is also directed to a method 300-340 for creating profit in the wholesale energy market 100. The method 300-340 has the steps of producing energy 300 in the wholesale energy market 100 during an off-peak period T2 at an off-peak period price P1, a first directing step 310 of directing the energy produced in the producing step 300 into a means for storing energy 50, storing 320 the energy in the means for storing energy 50, a second directing step 330 of directing the energy from the means for storing energy 50 into the wholesale energy market 100 during a peak period T2, and selling 340 the energy at a peak period price P2. The means for storing energy 50 of the method 300-340 may be provided in any of the embodiments described above. For example, the LMP averages about $15/MWHr hour during the off-peak period T1 and $37/MWHr during the peak period T2. Given these parameters, the present invention would provide a gross profit of $22/MWHr.

The methods 200-230 and 300-340 may have the further steps of lifting the mass 410 with the motor 30 and the means for lifting using the energy produced during the off-peak period T1 thereby creating a potential energy, and powering the generator 70 during the peak period T2 with the potential energy when the mass 410 is lowered with the means for lowering.

While the invention has been described with references to its preferred embodiments, it will be understood by those skilled in the art that various changes may be made and equivalents may be substituted for elements thereof without departing from the true spirit and scope of the invention. In addition, many modifications may be made to adapt a particular situation or material to the teaching of the invention without departing from its essential teachings.

I claim:

1. A system for storing energy during an off-peak period and distributing energy during a peak period in a wholesale energy market, said system comprising:
a first energy directing means for directing energy produced in the wholesale energy market during the off-peak period into an energy storage means for storing energy; and
a second energy directing means for directing energy from said energy storage means into the wholesale energy market during the peak period.

2. The system according to claim 1, wherein said energy storage means is selected from the group consisting of a pumped hydropower system, a compressed air energy storage system, a battery system, a flywheel system, a superconducting magnetic energy storage system, a supercapacitor system, a thermal energy storage system, and a mechanical potential energy storage system.

3. The system according to claim 1, wherein said energy storage means comprises a mechanical potential energy storage system including a mass, a lifting means for lifting said mass, and a lowering means for lowering said mass.

4. The system according to claim 3, wherein said mechanical potential energy storage system creates potential energy by lifting said mass with said lifting means using energy produced during the off-peak period; and
wherein said second energy directing means is powered by said potential energy during the peak period when said mass is lowered with said lowering means.

5. The system according to claim 1, wherein said energy storing means comprises a mechanical potential energy storage system selected from the group consisting of a pulley and cable system, a block and tackle system, a chain pull system, and a hydraulic system.

6. A method of storing energy during an off-peak period and distributing energy during a peak period in a wholesale energy market, said method comprising:
producing energy in the wholesale energy market during the off-peak period;
directing the produced energy into an energy storage means;
storing the produced energy in the energy storage means; and
directing the produced energy stored in the energy storage means into the wholesale energy market during the peak period.

7. The method according to claim 6, further comprising selecting the energy storage means from the group consisting of a pumped hydropower system, a compressed air energy storage system, a battery system, a flywheel system, a superconducting magnetic energy storage system, a supercapacitor system, a thermal energy storage system, and a mechanical potential energy storage system.

8. The method according to claim 6, further comprising:
configuring the energy storage means with a mechanical potential energy storage system including a mass, a motor, a means for lifting the mass connected to the motor, a generator, and lowering means for lowering said mass connected to the generator.

9. The method according to claim 8, further comprising:
creating potential energy by lifting the mass with the motor and the lifting means for lifting using the energy produced during the off-peak period; and
powering the generator during the peak period with the potential energy when the mass is lowered with the lowering means.

10. The method according to claim 6, further comprising configuring the energy storage means with a mechanical potential energy storage system selected from the group consisting of a pulley and cable system, a block and tackle system, a chain pull system, and a hydraulic system.

11. A method for creating profit in a wholesale energy market, said method comprising:
producing energy in the wholesale energy market during the off-peak period;
directing the produced energy into an energy storage means;
storing the produced energy the energy storage means;
directing the produced energy stored in the energy storage means into the wholesale energy market during the peak period; and
selling the produced and stored energy directed into the wholesale energy market during the peak period at a peak period price.

12. The method according to claim 11, further comprising selecting the energy storage means from the group consisting of a pumped hydropower system, a compressed air energy storage system, a battery system, a flywheel system, a superconducting magnetic energy storage system, a supercapacitor system, a thermal energy storage system, and a mechanical potential energy storage system.

13. The method according to claim 11, further comprising:
configuring the energy storage means with a mechanical potential energy storage system including a mass, a motor, a means for lifting the mass connected to the motor, a generator, and lowering means for lowering said mass connected to the generator.

14. The method according to claim 13, further comprising:
creating potential energy by lifting the mass with the motor and the lifting means for lifting using the energy produced during the off-peak period; and
powering the generator during the peak period with the potential energy when the mass is lowered with the lowering means.

15. The method according to claim 11, further comprising configuring the energy storage means with a mechanical potential energy storage system selected from the group consisting of a pulley and cable system, a block and tackle system, a chain pull system, and a hydraulic system.
